(19) United States
(12) Patent Application Publication
(10) Pub. No.: US 2026/0211230 A1
(43) Pub. Date: Jul. 23, 2026

(54) Multi-Channel MEMS-Based Spatial Light Modulator for High-Speed Amplitude and Phase Modulation

(71) Applicant: SILICON LIGHT MACHINES CORPORATION, San Jose, CA (US)

(72) Inventors: Michael Yeung, Fremont, CA (US); Alexander Payne, Ben Lommond, CA (US)

(73) Assignee: SILICON LIGHT MACHINES CORPORATION, San Jose, CA (US)

(21) Appl. No.: 19/442,479

(22) Filed: Jan. 7, 2026

Related U.S. Application Data
(60) Provisional application No. 63/742,814, filed on Jan. 7, 2025.

(51) Int. Cl. G02B 26/08

(52) U.S. Cl. CPC G02B 26/0841

(57) ABSTRACT

Microelectromechanical systems (MEMS) based spatial light modulators (SLM) are provided. Generally, the SLM includes an array of pixels arranged over a surface of a substrate, each pixel including at least one MEMS-based two-dimensional (2D) modulator, each modulator including an electrostatically displaceable reflective surface to modulate light incident thereon, and a pixel driver with linearized phase response. The pixel driver includes multiple channels, each operable to electrostatically displace the reflective surfaces in one or more pixels by a uniform, linearly increasing quantum up to a maximum displacement through application of non-linearly increasing drive voltages between an electrode coupled to the electrostatically displaceable reflective surface and an electrode in the substrate. The modulators are operable to modulate amplitude or phase of light incident on the SLM. The SLM can be a monolithic SLM in which the pixel driver is integrally formed on a substrate with the array of pixels using silicon-germanium modulators.

### CROSS-REFERENCE TO RELATED APPLICATIONS

This application claims the benefit of priority under 35 U.S.C. 119(e) to U.S. Provisional Patent Application Ser. No. 63/742,814, filed January 7, 2025.

### TECHNICAL FIELD

The present invention relates generally to multi-channel, MEMS-based spatial light modulators, and more particularly to circuits or drivers and methods for driving said MEMS for High-Speed Amplitude and Phase Modulation of light incident thereon.

### BACKGROUND

Spatial light modulators or SLMs include an array of one or more devices that can control or modulate an incident beam of light in a spatial pattern that corresponds to an electrical input to the devices. The incident light beam, typically generated by a laser, can be modulated in intensity, phase, polarization or direction. Spatial light modulators are increasingly being developed for use in various applications, including display systems, optical information processing and data storage, printing, maskless lithography, 3D printing, additive manufacturing, surface modification and optical phase modulators. SLMs using galvometeric mirrors to steer a single beam of modulated light continues to dominate many applications, however this approach is not easily extended to applications requiring multiple beams to achieve higher processing speeds. Other types of SLMs potentially useful in the aforementioned applications is a Microelectromechanical systems (MEMS) based SLMs including an array of independently, dynamically adjustable light reflective surfaces modulate the intensity and/or angle of light reflected from the array. Currently available MEMS-based SLMs include digital micro-mirror devices (DMDs), commercially available from Texas Instruments, and liquid-crystal-on-silicon (LCOS) modulators. In operation electromagnetic radiation or light from a coherent light source, such as a laser, is projected onto the array, and alignment of the mirrors is altered by electronic signals generating electrostatic forces to displace at least some of the mirrors to modulate the phase, intensity and or angle of light reflected from the array. While supporting multi beam applications and providing higher modulating speeds than single beam SLMs using galvometeric mirrors these existing MEMS-based SLMs have a number of disadvantages including their inability to provide fast beam steering and large scan angles necessary for many phase modulator applications. Fast beam steering requires the deflected mirrors to respond rapidly to a changing drive signal and to settle quickly and with minimal ringing or oscillation. The steering angle of a MEMS-based SLM is limited by the amount by which the mirrors can be moved while substantially preventing pull-in or snap-down of the deflected mirror to the substrate.

Accordingly, there is a need for MEMS-based SLM with high-power handling capabilities, rapid response fast beam steering and large steering angles. There is a further need for systems incorporating such a device.

### SUMMARY

A spatial light modulator (SLM) including an array of pixels arranged over a surface of a substrate, and a pixel driver with linearized phase response, and methods of fabricating and operating the same are described. Generally, each pixel includes at least one (MEMS)-based two-dimensional (2D) modulator, each MEMS modulator including an electrostatically displaceable reflective surface to modulate light incident thereon. The pixel driver includes multiple channels, each operable to electrostatically displace the reflective surfaces in one or more pixels by a uniform, linearly increasing quantum up to a maximum displacement through application of non-linearly increasing drive voltages between a ground or actuator electrode coupled to the electrostatically displaceable reflective surface and a high voltage (HV) or substrate electrode in the substrate. The MEMS modulators are operable to modulate amplitude or phase of light incident on the SLM, or both. In some embodiments the SLM is a monolithic SLM in which the pixel driver is integrally fabricated using (CMOS) technology in and/or on the same substrate with an array of pixels including MEMS-based 2D modulators fabricated using a low-temperature silicon-germanium (SiGe) process.

In another aspect, a method for operating a MEMS-based SLM including an array of pixels and a pixel driver having a linearized phase response is provided. Generally, the method includes or begins with the step of coupling multibit image data, a data clock, a data strobe and a frame strobe to the pixel driver. Upon receipt of the data strobe the multibit image data is sequentially latched to a number of cascaded registers in the pixel driver on both rising and falling edges of the data clock. Next, the latched multibit image data is converted to complementary output currents using a non-linear, differential, current mode digital-to-analog-converter (DAC). The complementary output currents are coupled through a cascode amplifier and a pair of parallel load resistors to a high voltage power supply (HVPS), and transformed into a drive voltage to drive MEMS modulators in one or more pixels in the array. As noted above each MEMS modulator includes an electrostatically displaceable reflective surface to modulate light incident thereon. The drive voltage is operable to electrostatically displace the reflective surfaces in one or more modulators in one or more pixels by a uniform, linearly increasing quantum up to a maximum displacement through application of non-linearly increasing drive voltages between a ground or actuator electrode coupled to the electrostatically displaceable reflective surface and a high voltage (HV) or substrate electrode in a substrate on or over which the array is fabricated.

Further features and advantages of embodiments of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to a person skilled in the relevant art(s) based on the teachings contained herein.

### BRIEF DESCRIPTION OF THE DRAWINGS

Embodiments of the invention will now be described, by way of example only, with reference to the accompanying schematic drawings in which corresponding reference symbols indicate corresponding parts. Further, the accompanying drawings, which are incorporated herein and form part of the specification, illustrate embodiments of the present invention, and, together with the description, further serve to explain the principles of the invention and to enable a person skilled in the relevant art(s) to make and use the invention.

FIGS. 1A and 1B are block diagrams illustrating a spatial light modulator (SLM) including an array of pixels, each pixel including a number of microelectromechanical system (MEMS)-based two-dimensional (2D) modulators, and a pixel driver including multiple drive channels configured to provide a linearized phase response;

FIGS. 2A to 2C are block diagrams illustrating planar light valve (PLV^{TM}) type 2D modulators for use in a SLM for amplitude modulation;

FIGS. 3A to 3C are block diagrams illustrating a complex or displacement phase modulator (DPM^{TM}) type 2D MEMS modulators for use in a MEMS-based SLM for phase or phase and amplitude modulation;

FIG. 4 schematically illustrates forces on a flexure or actuator layer for a single, 2D MEMS modulator and a resulting deformation;

FIGS. 5A to 5C are cross-sectional views of various embodiments of hybrid SLM including an array of pixels electrically coupled to a complementary metal–oxide–semiconductor (CMOS) pixel driver with linearized phase response fabricated on a separate substrate;

FIG. 6 is a schematic block diagram illustrating a cross-sectional view of a portion of a directly integrated SLM including an array of high temperature 2D modulators integrally fabricated adjacent to a CMOS pixel driver in or on a single substrate;

FIG. 7 a schematic block diagram illustrating a cross-sectional view of a portion of a directly integrated SLM including an array of low temperature 2D modulators integrally fabricated overlying a CMOS pixel driver in or on a single substrate;

FIG. 8 is a flowchart of a method for fabricating a monolithic MEMS-based SLM including an array of low temperature 2D modulators integrally fabricated overlying a CMOS pixel driver in or on a single substrate;

FIG. 9 is an intermediate MEMS structure of the 2D modulator formed by the method of FIG. 8;

FIGS. 10A and 10B are simplified schematic block diagrams illustrating a PLV^{TM} type 2D modulator for use in a monolithic MEMS-based SLM, formed by a low temperature MEMS process;

FIGS. 11A and 11B are simplified schematic diagrams illustrating a DPM^{TM} type 2D modulator for use in a monolithic MEMS-based SLM, formed by a low temperature MEMS process;

FIG. 12A is a schematic block diagram illustrating a planar top view of a portion of a monolithic MEMS-based SLM including a multi-pixel, linear array of dense-packed, MEMS-based 2D modulators;

FIGS. 12B is a schematic block diagram illustrating a planar top view of a pixel for use in the array of FIG. 12A, and including a 2x2 arrangement of PLV^{TM} type 2D modulators;

FIGS. 12C is a schematic block diagram illustrating a planar top view of a pixel for use in the array of FIG. 12A, and including a 2x2 arrangement of DPM^{TM} type 2D modulators;

FIG. 13 is a schematic diagram modeling 2D modulator as a capacitor-on-a-spring;

FIGS. 14A to 14C illustrate a finite-element-analysis (FEA) of a flexure or actuator layer of the 2D modulator to derive non-linear drive voltages to operate the 2D modulator in linearly;

FIG. 15 is a plot of data points representing deflection or displacement versus voltage (d-V) for a 2D modulator driven using drive voltages derived from the FEA of FIGS. 14A to 14C;

FIG. 16 is a deflection or displacement versus DAC output curve for a 2D modulator driven using linear voltages derived from the FEA of FIGS. 14A to 144C, and illustrating substantially linear deflection increments;

FIG. 17 is a schematic block diagram of a 32x256 CMOS pixel driver with linearized phase response and modular tiling of 16 identical 512-channel blocks;

FIG. 18 is a schematic block diagram of a single drive channel in a pixel driver with linearized phase response;

FIG. 19 is a schematic diagram of a non-linear digital-to-analog converter (DAC) with a dual-stage architecture, and including a 3-bit most significant bit (MSB) primary-DAC and 4-bit least significant bit (LSB) interpolator;

FIG. 20 is a schematic block diagram of a dual-pixel layout including high voltage p-type metal on semiconductor (HV PMOS) transistors and poly-silicon load resistors;

FIG. 21 is a flowchart of a method for operating a MEMS-based SLM including an array of pixels with 2D modulators and a pixel driver with linearized phase response;

FIG. 22 is a curve illustrating the spectral efficiency of an amplitude modulating SLM driven by a non-linear pixel driver; and

FIG. 23 is a plot of deflection of the reflective surfaces of an amplitude modulating SLM driven by a non-linear pixel driver versus the DAC output.

### DETAILED DESCRIPTION

A spatial light modulator (SLM) including a two-dimensional (2D) array of pixels arranged over a surface of a substrate, and a pixel driver with linearized phase response, and methods of fabricating and operating the same are described herein with reference to the figures described above.

In the following description, for purposes of explanation, numerous specific details are set forth in order to provide a thorough understanding of the present invention. It will be evident, however, to one skilled in the art that the present invention can be practiced without these specific details. In other instances, well-known structures, and techniques are not shown in detail or are shown in block diagram form in order to avoid unnecessarily obscuring an understanding of this description.

Reference in the description to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment. The term to couple as used herein can include both to directly electrically connect two or more components or elements and to indirectly connect through one or more intervening components.

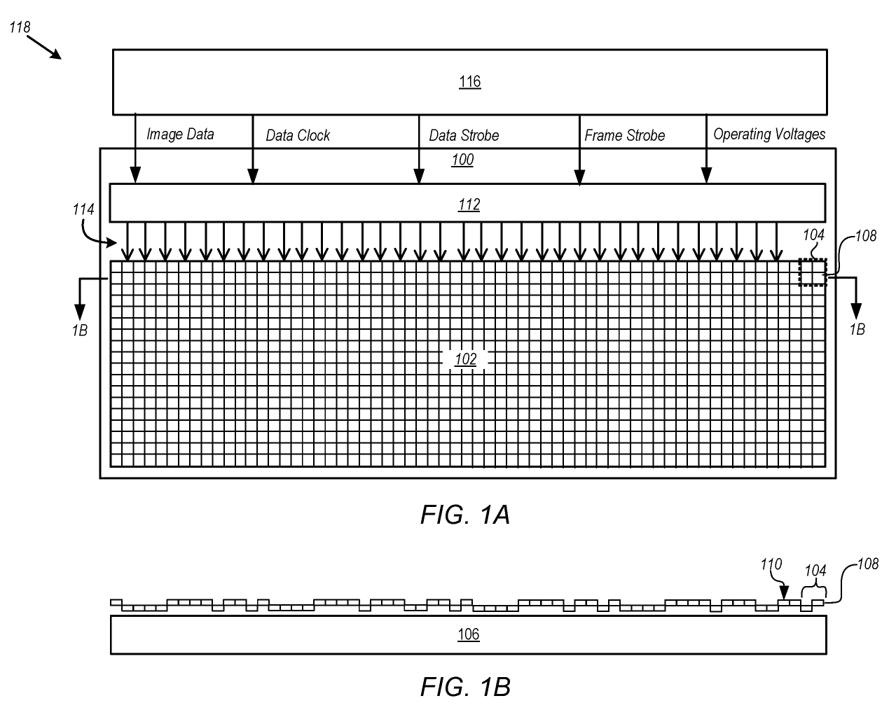

An embodiment of a spatial light modulators (SLM) including a multi-pixel, array of Microelectromechanical systems (MEMS) based two-dimensional (2D) modulators will now be described with reference to FIGS. 1A and 1B. FIG. 1A is a block diagram illustrating an embodiment of a SLM in a top or planar view. FIG. 1B is a block diagram illustrating a portion of the array in sectional side view.

For purposes of clarity, many of the details of SLMs in general and MEMS-based 2D modulators in particular that are not relevant to the present invention have been omitted from the following description. The drawings described are only schematic and are non-limiting. In the drawings, the size of some of the elements may be exaggerated and not drawn to scale for illustrative purposes. The dimensions and the relative dimensions may not correspond to actual reductions to practice of the invention.

Referring to FIGS. 1A and 1B in the embodiment shown, the SLM 100 includes an array 102 of pixels 104 arranged over a surface of a substrate 106, each pixel including at least one microelectromechanical system (MEMS) based 2D modulator 108, wherein each MEMS modulator 108 includes at least one reflective surface 110 that is electrostatically displaceable relative to the surface of the substrate to modulate a coherent light incident thereon. The SLM 100 further includes a multi-channel, pixel drive circuit or pixel driver 112 having a number of drive channels 114 each coupled to one or more 2D modulators 108 in one or more pixels 104 in the array 102. The pixel driver 112 can be integrally formed on the same substrate 106 with the array 102, as in the embodiment shown, or formed on a second substrate or chip and electrically coupled thereto (not shown). The pixel driver 112 is electrically coupled to a controller 116 in a system 118 incorporating the SLM 100 to receive multibit image data, a data clock, a data strobe, a frame strobe and operating voltages therefrom. Generally, as described in greater detail hereinafter, the pixel driver 112 is configured or designed to provide a linearized phase response in which each drive channel is operable to electrostatically displace the reflective surfaces of the 2D modulators in one or more pixels by a uniform, linearly increasing quantum up to a predetermined maximum displacement in response to a non-linearly increasing electrostatic drive voltage applied between an actuator electrode coupled to the electrostatically displaceable reflective surface and a substrate electrode in the substrate.

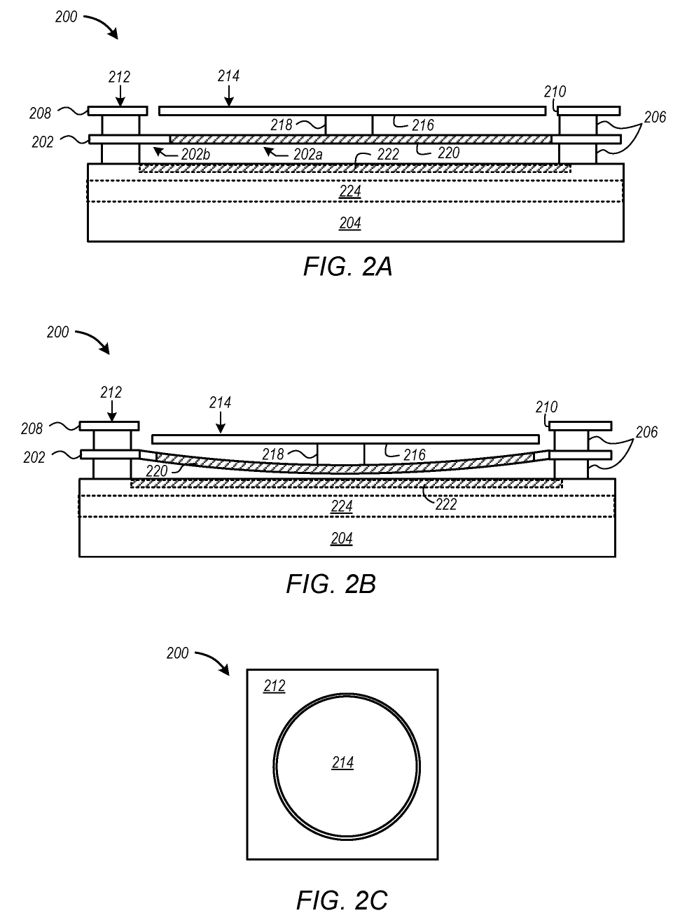

FIGS. 2A to 2C illustrate an embodiment of 2D modulators suitable for use in an array of a MEMS-based SLM for amplitude modulation. One example of such a 2D modulator is known as a planar light valve (PLV^{TM}), and is commercially-available from Silicon Light Machines, Inc., of San Jose, California. For purposes of clarity, many of the details of fabricating and operating PLVs^{TM}, which are widely known and not relevant to the present invention, have been omitted from the following description. PLVs^{TM} are described in greater detail, for example, in commonly assigned U.S. Patent Serial No. 7,064,883, entitled, “Two-Dimensional Spatial Light Modulator,” by Alexander Payne et al., issued on June 20, 2006, and incorporated herein by reference in its entirety.

FIG. 2A illustrates a schematic block diagram of a sectional side view of a PLV type 2D modulator 200 in a quiescent or un-driven state. Referring to FIG. 2A, the 2D modulator 200 generally includes a flexure or actuator layer 202 suspended over a surface of a substrate 204 by posts 206 at corners of the 2D modulator. The actuator layer 202 includes an electrostatically deflectable central portion or piston 202a and a number of flexures 202b through which the piston is flexibly or movably coupled to the posts 206. A faceplate 208 overlying the actuator layer 202 includes a first light reflective surface 210 and an aperture or cut-out portion 212 which separates the faceplate from a second reflective surface 214 on or attached to the piston 202a. The second light reflective surface 214 can either be formed directly on the top surface of the piston 202a, or, as in the embodiment shown, on a mirror 216 supported above and separated from the piston 202a by a central post 218 extending from the piston to the mirror. The first and second light reflective surfaces 210, 214, have equal area and reflectivity so that in operation electrostatic deflection of the piston 202a caused by an electrode 220 formed in or on the actuator layer 202 and an electrode 222 in the substrate 204 brings light reflected from the first light reflective surface 210 into constructive or destructive interference with light reflected from the second light reflective surface 214.

Generally, the actuator layer 220 can include a taut film or layer of a dielectric or semiconducting material, such as silicon (Si), silicon-dioxide (SiO₂), silicon nitride (SiN), silicon-oxynitride (SiN) or silicon-germanium (SiGe). Where the actuator layer 220 includes SiGe it may also serve as the electrode 220. Alternatively, if the reflective layer 210 is metallic it may also serve as the electrode 220.

The electrode 222 in the substrate 204 is coupled to one of a number drive channels in a drive circuit or driver 224, which can be integrally formed in the substrate adjacent to or underlying the 2D modulator 200, as in the embodiment shown. The electrode 222 in the substrate 204 can be coupled to the driver 224 through a via extending through the substrate from the driver to the electrode, and the electrode 220 formed in or on the actuator layer 202 can be coupled to the driver or an electrical ground through a conductor extending through one of the posts 206 and the actuator layer. As explained in greater detail below, typically multiple individual 2D modulators 200 are grouped or ganged together under control of a single drive channel to function as a single pixel in the multi-pixel, linear array of the SLM.

FIG. 2B is a schematic block diagram of the 2D modulator 200 of FIG. 2A in an active or driven state, showing the piston 202a deflected towards the substrate 204, and FIG. 2C is a top view of the 2D modulator of FIGS. 2A and 2B illustrating the static first light reflective surface 210 and the movable second light reflective surface 214.

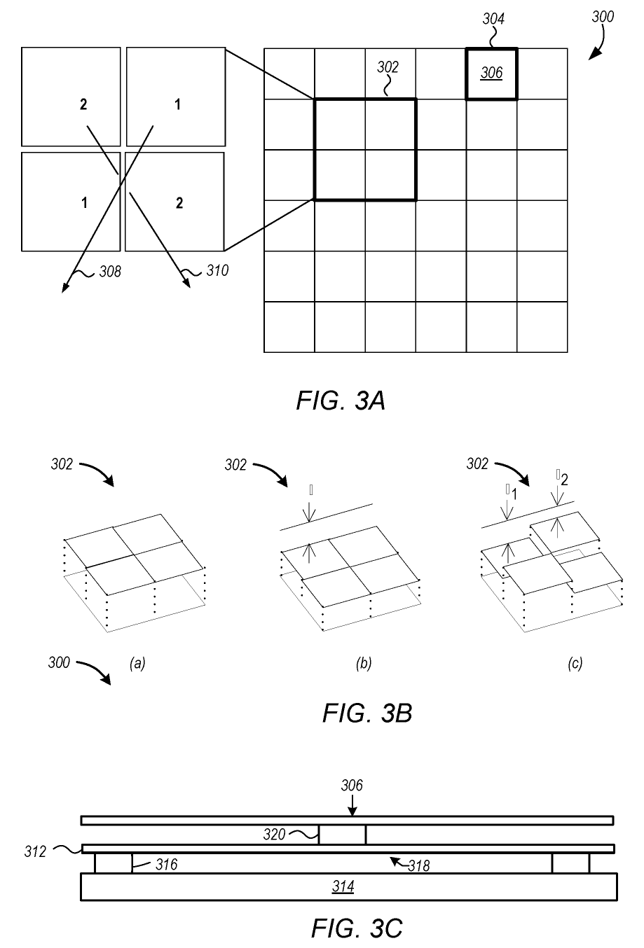

FIGS. 3A to 3C illustrate another embodiment of a 2D modulator suitable for use in a MEMS-based SLM for phase or phase and amplitude modulation. One example of such a 2D modulator is known as a complex or displacement phase modulator (DPM^{TM}), and is commercially-available from Silicon Light Machines, Inc., of San Jose, California. For purposes of clarity, many of the details of fabricating and operating DPMs^{TM}, which are widely known and not relevant to the present invention, have been omitted from the following description. DPMs^{TM} are described in greater detail, for example, in commonly assigned U.S. Patent Serial No. 7,227,687, entitled, “Complex Spatial Light Modulator,” by Jahja Trisnadi, et al., issued on June 5, 2007, and incorporated herein by reference in its entirety.

Briefly, the SLM 300 includes multiple pixels 302, each pixel including multiple DPMs 304. The DPMs 304 each include an electrostatically displaceable mirror or reflective surface 306. The DPMs 304 are configured such that substantially all light reflected from the SLM 300 comes from the DPMs. Preferably, DPMs 304 along diagonal lines 308, 310, are coupled to deflect in unison, by electrically interconnecting drive electrodes (not shown) below each phase shift modulator and applying a common drive voltage. In this way, each pixel 302 receives two independent driving voltages to deflect diagonally opposed DPMs 304 as a group, denoted as group 1 and group 2 in FIG. 3A. The two groups, of each pixel 302 can be controlled independently of the other pixels to allow coherent light reflected from one pixel to constructively or destructively interfere with light reflected from one or more adjacent pixels, thereby modulating the light incident thereon. More preferably, the DPMs 304 are deflectable through one or more wavelengths of light to enable both the phase and the amplitude of the reflected light to be modulated independently. FIG. 3B illustrates perspective views of a pixel 302 of the SLM 300 of FIG. 3A in (a) quiescent, (b) phase-modulated and (c) amplitude and phase modulated mode, where δ is equal to a quarter wavelength of the light incident on the SLM.

FIG. 3C depicts a cross-sectional view of a single, 2D phase shift modulator 304 in the SLM 300. Referring to FIG. 3C, the phase shift modulator 304 generally includes a film or membrane 312 disposed above an upper surface of a substrate 314 by a number of posts 316 with a displaceable or movable actuator or piston 318 formed thereon. Supported above and affixed to each piston 318 by a support structure or central post 320 is the reflective surface 306 or mirror that is positioned generally parallel to the surface of the substrate 314 and oriented to reflect light incident on a top surface of the SLM 300. The piston 318 and the associated reflective surface 306 form the individual phase shift modulator 304.

Individual pistons 318 or groups of pistons are moved up or down over a very small distance (typically only a fraction of the wavelength of light) relative to the substrate 314 by electrostatic forces controlled by drive electrodes (not shown) in the substrate underlying the actuator membrane 312. Preferably, the pistons 318 can be displaced by n*λ/2 wavelength, where λ is a particular wavelength of light incident on the SLM 300, and n is an integer equal to or greater than 1. Moving the piston 318 brings reflected light from the planar light reflective surface 306 of one phase shift modulator 304 into constructive or destructive interference with light reflected by adjoining DPMs in a pixel, thereby modulating light incident on the SLM 300.

Materials of the reflective surfaces of the PLV type 2D modulator 200, and the DPM 300 are selected so that the SLM is operable to modulate light ranging from deep ultraviolet light (DUV) to near-infrared (NIR) at wavelengths from 150 nm to 2µm. Suitable reflective materials can include aluminum (Al), gold (Au), silver (Ag) or any other suitably reflective metal. Alternatively, the reflective surfaces can include a multilayer dielectric or Bragg mirror including one or more alternating layers with different optical characteristics or properties, such as reflection, transmission and absorption depending on the wavelengths of the incident light being modulated.

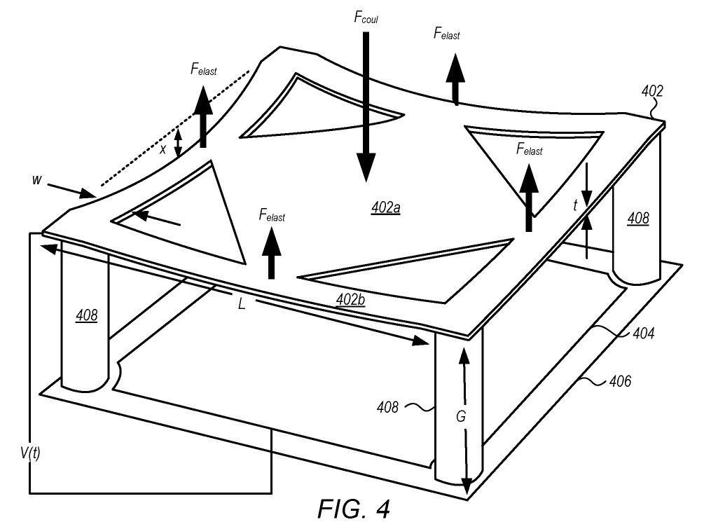

FIG. 4 schematically illustrates a flexure or actuator layer for a single 2D modulator and shows forces thereon resulting in deformation or movement. Referring to FIG. 4 the actuator layer 402 generally includes an electrostatically deflectable patterned central plate or piston 402a and a number of flexures 402b through which the piston is suspended over a common electrode 404 in a substrate 406 by a number of posts 408 at corners thereof. Generally, the actuator layer 402 includes a taut, structural layer of tensile, amorphous silicon-germanium (SiGe layer) that also functions as an actuator electrode. By tensile, amorphous SiGe layer it is meant a layer of silicon-germanium with a molecular formula of the form Si₁₋ xGex that has been formed or processed to yield a layer substantially free of any crystalline structure, and having a modulus of elasticity from about 100 to about 120 GigaPascals (GPa), and more preferably about 110 GPa.

The SiGe layer can be a low temperature SiGe layer deposited using chemical vapor deposition (CVD), plasma enhanced CVD (PECVD) at a temperature of less than about 500 C to enable the 2D modulators to be formed over the substrate following fabrication of the driver without restricting layout of the driver or deleteriously impacting functioning CMOS transistors and devices of the driver. Preferably, the SiGe layer is further processed after deposition under conditions to yield a taut structural layer of tensile, amorphous SiGe. The processing can include implanting the SiGe layer with impurities at a concentration selected to change stress in the SiGe layer from a compressive stress to a tensile stress, followed by a low temperature (less than about 500 C) annealing of the implanted SiGe layer. More preferably, the SiGe layer is implanted with a dopant, which serves not only to change the stress in the SiGe layer to tensile but also to form a conductive implanted SiGe layer that also functions as the actuator electrode. Suitable impurities and dopants include Boron (B), Aluminum (Al), Gallium (Ga), Indium (In), Silicon (Si), Gold (Au) Xenon (Xe) Nitrogen (N), and Argon (Ar), ion implanted to a concentration of about from about of about 1E13 atoms/cm³ to about of about 1E18 atoms/cm³.

Referring to FIG. 4, a voltage potential (V(t)) applied between the actuator layer 402 and the common electrode 404 creates an electrostatic Coulomb attraction (F coul in FIG. 4) that deflects the actuator layer a distance x towards the common electrode. The electrostatic force is balanced by an elastic restoring force (F elast in FIG. 4). The elastic restoring force, which is due to taut, tensile SiGe layer in the actuator layer 402, allows the actuator layer to revert back to a neutral state or position once the electrostatic force is removed.

Many applications spatial light modulator technologies require the MEMS-based 2D modulators be coupled to high-performance multi-channel complementary metal–oxide–semiconductor (CMOS) drivers. Generally, this coupling can be accomplished either through hybrid integration in which the 2D modulators and CMOS drivers are fabricated as separate integrated circuits (ICs) and then electrically coupled, or direct integration in which the 2D modulators and CMOS drivers are integrally fabricated on a single common or shared substrate or wafer, typically a semiconductor substrate, to form a monolithic MEMS-based SLM.

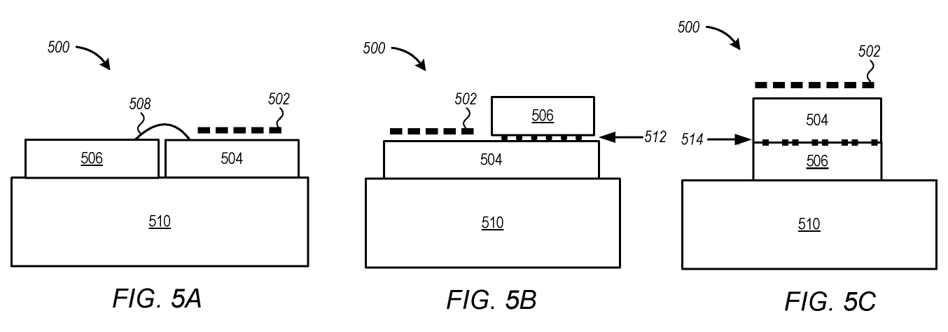

FIGS. 5A to 5C are cross-sectional views of various embodiments of hybrid SLM 500 including an array of MEMS-based 2D modulators 502 fabricated on a first, MEMS IC 504 and electrically coupled to CMOS drivers fabricated on a second, CMOS IC 506. In the embodiment illustrated in FIG. 5A the 2D modulators 502 are fabricated on a passive silicon-nitride, MEMS IC 504 and wire-bonded 508 to high-performance, multi-channel CMOS drivers fabricated on a semiconducting, CMOS IC 506, and both ICs are mounted to a common printed circuit board (PCB 510). This approach works well for SLMs 500 with one to several hundred CMOS drive channels, each driving one or more multi-modulator pixels. However, due to limitations in bond pad size and pitch, such approach is not practical for SLMs approaching a thousand or more drive channels.

In an alternative hybrid integration approach, shown in FIG. 5B, solder bumps 512 are formed on pads of the CMOS IC 506 and the IC flipped upside down to align and electrically couple with pads on the passive MEMS IC 504. This approach can support SLMs 500 having a thousand or more drive channels; however it cannot be used for embodiments in which the CMOS drivers are desirably located underneaththe array of 2D MEMS modulators to reduce an overall size of the SLM 500 and/or electrical paths between the 2D modulators and CMOS drivers for high-speed operation.

Yet another hybrid integration solution, shown in FIG. 5C, utilizes through silicon vias (TSVs 514) to electrically couple the MEMS IC 504 stacked directly on top of the CMOS IC 506. This approach can support SLMs 500 having several thousand drive channels, while also enabling the CMOS drivers to be located underneaththe array of 2D MEMS modulators to reduce an overall size of the SLM. However, limitations in minimum pitches the state-of-the-art TSV, which are much larger than the pitch of the 2D modulators, wafer thinning requirements for the MEMS IC 504, commonly to less than 300 µm, and thermal constraints of the TSVs, typically made with tungsten, render it incompatible with very high count SLMs 500, i.e., ten thousand drive channels or more, as well as with high-temperature, silicon nitride (SiN) MEMS processes used to fabricate the 2D modulators.

Thus, a direct integration approach is desired for compact SLMs and/or SLMs having high pixel or channel counts of one to ten thousand or more. Additionally, direct integration has a further advantage over hybrid integration for high-speed 2D modulators. Bond-pads, bond-wires, solder bumps and other macro-interconnects constitute a parasitic capacitive load on the driver, increasing a resistor-capacitor (RC) time-constant of the driver and limiting pixel switching speed. Capacitances of MEMS-based 2D modulators are on the order of 10 femtofarads (fF) – miniscule relative to the pico-farads (pF) capacitance presented by such macro-interconnects. Driving such capacitances at high speed generally requires increased power consumption.

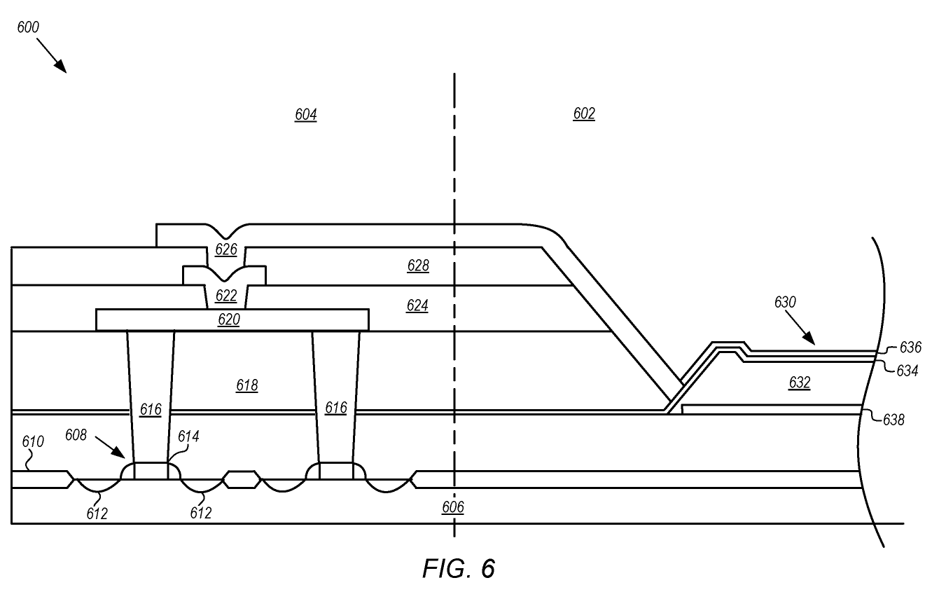

A first direct integration solution is shown in FIG. 6. FIG. 6 is a schematic block diagram illustrating a cross-sectional view of a portion of a directly integrated SLM 600 including an array of high temperature MEMS-based 2D modulators 602 integrally fabricated adjacent to a CMOS pixel driver 604 in or on a single substrate 606. Referring to FIG. 6, the CMOS pixel driver 604 generally includes a plurality of transistors 608 separated by isolation structures, such as field oxidation (FOX 610) and including doped source-drain regions 612 and gates 614 formed in the substrate 606 adjacent to and/or underlying the 2D modulators 602. Contacts 616 extend through openings etched in a dielectric layer 618 covering the transistors 608 to electrically couple gates 614 of the transistors and other regions in the substrate 606 to a local interconnect (LI 620) for the wiring of the CMOS pixel driver 604. Additional alternating metal and dielectric layers are formed over the LI 620 to electrically couple thereto. It has been found that reasonably sophisticated circuit designs, such as those used to operate or drive a 2D modulators 602, can be realized with a CMOS pixel driver 604 including a total of three to five metal layers including the LI. In the embodiment shown, the CMOS pixel driver 604 includes a first patterned metal layer (M1622) overlying a first inter-level dielectric layer (ILD 624) and patterned to form contacts electrically coupled to the LI 620, and a second patterned metal layer (M2626) overlying a second ILD 628 electrically coupled to the metal layer. Optionally, each layer of metallization, i.e., LI 620, M1622 and M2626, and the entire CMOS pixel driver 604 are covered by cap-oxides (not shown).

The 2D modulators 602 generally includes at least one moveable actuator 630, a portion of which is suspended above the substrate 606 and separated therefrom by an air-gap 632 or void formed by the removal of a sacrificial layer (not shown) following formation of the actuator. Where the 2D modulators 602 is a diffractive, spatial light modulator (SLM), the actuator 630 generally includes a layer of elastic material, such as silicon nitride layer 634, covered or overlaid by a film or layer of metal 636 that serves as both an actuator electrode and a reflective surface for the SLM. In operation the actuator 630 is electrostatically deflected or moved towards a bottom electrode 638 formed in or on a surface of the substrate 606 by application of a voltage differential applied between the electrode and the layer of metal 636 of the actuator.

As noted above, one problem with manufacture of directly integrated SLMs using conventional fabrication techniques is that the metallization used to form the interconnects and contacts of the CMOS pixel driver 604 cannot withstand the high temperature processes used to fabricate the 2D modulators 602. Thus, the 2D modulators 602 must be fabricated first, after the forming of the transistors 608, prior to the metallization to form the CMOS pixel driver 604, and material overlying the MEMS removed in an open array etch step. This has a number of negative impacts on fabrication of the SLM 600. First, the MEMS is overlaid with a number of alternating metal and dielectric layers that must be removed after completion of the CMOS pixel driver. Second, no contacts 616, and therefore few or no transistors, can be formed under the MEMS, thereby increasing the surface area of the device dedicated to the CMOS pixel driver 604 and correspondingly decreasing the area of the MEMS and the optical efficiency. Finally, the conventional approach typically results in high aspect ratio contacts 616, which are problematic from a standpoint of yield of working devices, and can limit the number of layers of metallization in the CMOS pixel driver, since it is undesirable to have too many layers overlying the MEMS that must be removed, and the MEMS is susceptible to damage through over etching used in the metallization processes.

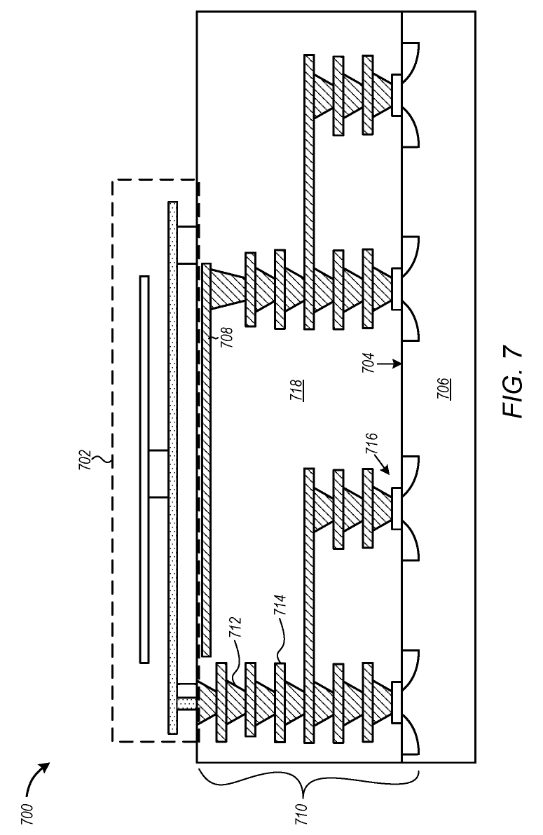

Yet another direct integration solution, shown in FIG. 7, the SLM is a SLM 700 utilizing 2D modulators fabricated using a low temperature MEMS technology. FIG. 7 a schematic block diagram illustrating a cross-sectional view of a portion of a directly integrated SLM including an array of low temperature 2D modulators integrally fabricated overlying a CMOS pixel driver in or on a single substrate. Referring to FIG. 7, the SLM 700 includes a number of 2D modulators 702, only one of which is shown, formed on or overlying a surface 704 of a substrate 706, a common electrode 708 formed in or on the surface of the substrate, and a driver 710 integrally formed in and on the substrate below the 2D modulators. The driver 710 generally includes multiple layers of vias 712, metal layers 714, and devices or transistors 716 fabricated in the substrate 706 and in a number of dielectric layers 718 overlying the surface of the substrate using a CMOS technology. Generally, the driver 710 includes as many as six to eight metal layers, and lies partially or completely under one or more of the 2D modulators 702 and the common electrode 708, and the 2D modulators 702 each include an electrostatically displaceable actuator (not shown in this figure) suspended above an upper surface of the substrate. The driver 710 is coupled to the common electrode 708 and to movable actuators in the 2D modulators 702 through a number vias 712 and/or metal layers 714.

It is noted that although, only a single 2D modulator 702 is shown in FIG. 7, it will be understood that as explained in greater detail below the SLM 700 can and generally does include an array of from several hundred to several thousand 2D modulators overlying a shared common electrode 708, with a number of 2D modulators electrically coupled to a single drive channel to function as a single pixel.

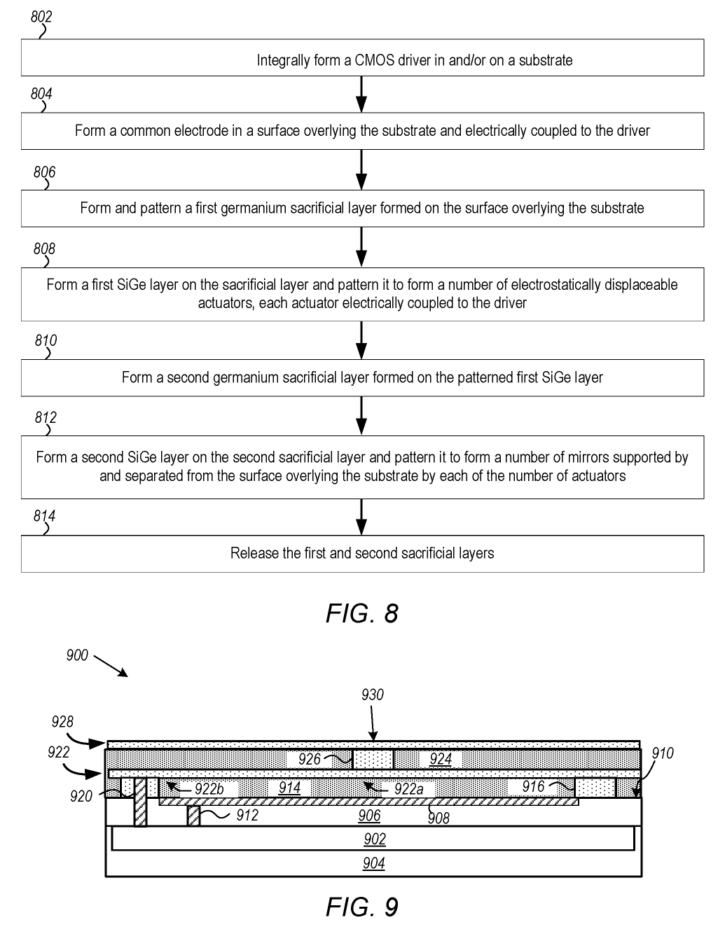

A method of fabricating a 2D modulator using a low temperature MEMS technology will now be described with reference to the flowchart of FIG. 8 and the intermediate MEMS structure 900 of FIG. 9. Referring to FIGS. 8 and 9, the method begins with integrally forming a CMOS driver 902 in and/or on a substrate 904 (step 802). Generally, the driver 902 includes multiple layers of vias, metal interconnect layers, and CMOS transistors or devices, formed in the substrate or in dielectric layers 906 overlying the substrate using standard semiconductor fabrication techniques.

Next, a common electrode 908 is formed in or a surface 910 overlying the substrate 904 and electrically coupled to the driver 902 through a via 912 (step 804).

A first germanium sacrificial layer 914 is then formed on the surface 910 overlying the substrate 904 and patterned (step 806). Patterning the first germanium sacrificial layer 914 generally includes forming a number of holes for posts 916 that will subsequently be formed to support an actuator and an electrically insulated contact 920 that will electrically couple the actuator to the driver 902.

A first SiGe layer is then formed on the first sacrificial layer 914 and patterned to form a number of electrostatically displaceable actuators 922, each actuator electrically coupled to the driver (step 808). Generally, the first SiGe layer is a conformal layer of silicon-germanium that fills the post holes to form the posts 916, and is patterned to form an electrostatically displaceable actuator 922 including a central plate (CP 922a) and a number of flexures 922b through which the CP is flexibly coupled to the posts. The actuator 922 is electrically coupled to the driver 902 through the electrically insulated contact 920. The first SiGe layer is formed by CVD or PECVD deposition at a low temperature of less than about 500 C to yield an amorphous first SiGe layer, and is implanted with impurities at a concentration selected to change stress in the first SiGe layer from a compressive stress to a tensile stress to form a tensile, amorphous first SiGe layer. Generally, the first SiGe layer is annealed at a low temperature of less than about 500 C following the ion implant.

Next, a second germanium sacrificial layer 924 is formed on the patterned first SiGe layer and patterned (step 810). Patterning the second germanium sacrificial layer 924 generally includes forming a hole for a center post 926 that will subsequently be formed to support a number of mirrors 928 above each of the electrostatically displaceable actuator 922.

A second SiGe layer is then formed on the second sacrificial layer 924 and patterned to form the mirror 928 supported by and separated from the surface 910 overlying the substrate 904 by each of the number of actuators 922 (step 812). As with the SiGe layer used to form the actuators 922, the second SiGe layer is a conformal layer that fills the hole for the center post 926. The second SiGe layer is formed by CVD or PECVD deposition at a low temperature of less than about 500 C to yield an amorphous second SiGe layer, and is implanted with dopant ions or impurities at a concentration selected to change stress in the second SiGe layer from a compressive stress to a tensile stress to form a tensile, amorphous first SiGe layer. Generally, the second SiGe layer is annealed at a low temperature of less than about 500 C following the ion implant.

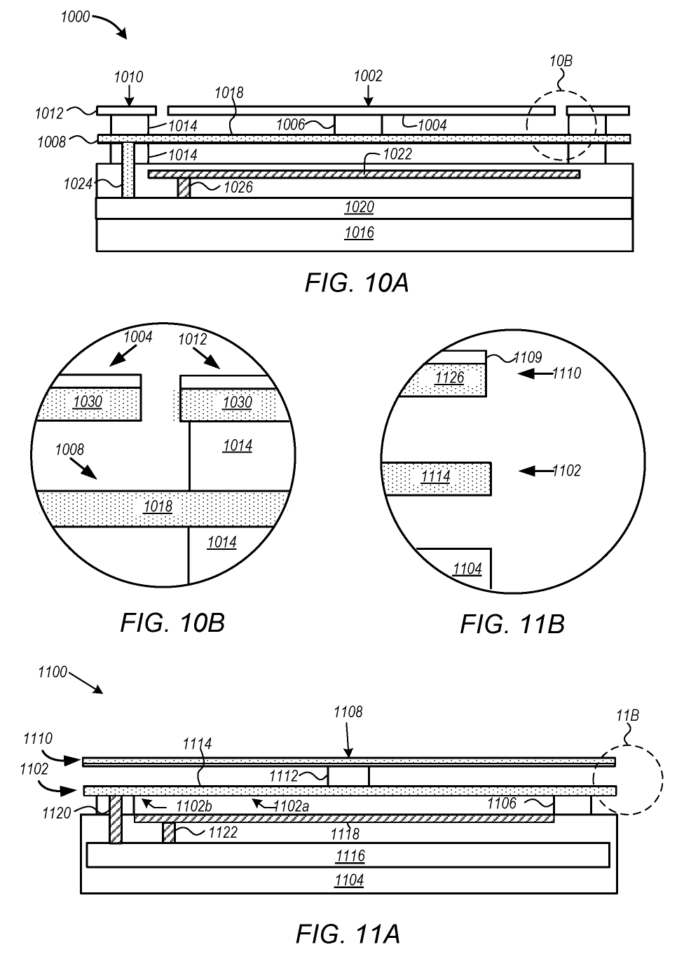

A reflective surface 930 is formed on the mirrors 928 to yield the MEMS structure shown in FIG. 9, and the first germanium sacrificial layer 914 and the second germanium sacrificial layer 924 are etched or removed to release the mirrors 928 and actuators 922, resulting in a 2D modulator as shown in FIGS. 10A to 10B and FIGS. 11A to 11B (step 814).

FIGS. 10A and 10B illustrate a PLV^{TM} type 2D modulator 1000 formed using low temperature MEMS technology and including a first reflective surface 1002 formed on a mirror 1004 supported by a central post 1006 above an electrostatically displaceable actuator layer 1008, and a second light reflective surface 1010 on a static faceplate 1012 disposed about or surrounding the mirror.

FIG. 10A illustrates a schematic block diagram of a sectional side view of the 2D modulator 1000 in a quiescent or un-driven state. Referring to FIG. 10A, it is noted that the first light reflective surface 1002 and the second light reflective surface 1010 are sized and shaped to define reflective areas with substantially equal reflectivity, so that in operation deflection of the first light reflective surface brings light reflected therefrom into constructive or destructive interference with light reflected from the second light reflective surface to provide maximum contrast. When the 2D modulator 1000 is in a quiescent or undriven state and the first light reflective surface 1002 and the second light reflective surface 1010 are co-planar, the 2D modulator is fully reflective. When the first light reflective surface 1002 is displaced from the second light reflective surface 1010 by a distance equal to n*λ/4, where n is an odd integer and λ is the wavelength of the incident light, the 2D modulator is in a fully diffracting or dark state. Generally, the driver and 2D modulator are operable to electrostatically displace the actuator layers in an analog range of distances so that a gray scale is achieved in the magnitude of the light reflected by the SLM.

Referring to FIG. 10A, the faceplate 1012 overlying the actuator layer 1008 and separated therefrom by extensions of posts 1014. The actuator layer 1008 includes a taut, structural layer of tensile, amorphous SiGe (SiGe layer 1018), which also functions as an actuator layer electrode.

The monolithic MEMS-based SLM further includes a driver 1020 integrally formed in and/or on the substrate 1016 at least partially underlying the 2D modulator 1000 and a common electrode 1022 formed in the substrate or in a dielectric layer on the substrate. The driver 1020 is operable to generate a voltage between the common electrode 1022 and the SiGe layer 1018 in the actuator layer 1008 to cause displacement of the CP 1008a. The SiGe layer 1018 is electrically coupled to one of a number drive channels in the driver 1020 through a conductor 1024 extending through one or more of the posts 1014, and to the common electrode 1022 through one or more vias 1026 and metal layers (not shown in these figures).

FIG. 10B is detailed view of a portion of the faceplate 1012, the actuator layer 1008, and the mirror 1004 of the 2D modulator 1000 shown in FIG. 10A. Referring to FIG. 3B, as in the embodiment described above, the SiGe layer 1018 can be deposited using CVD, or PECVD, preferably at a temperature of less than about 500 C to yield an amorphous SiGe layer. More preferably, the SiGe layer 1018 is implanted, and annealed under conditions described above to yield a taut structural layer of tensile, amorphous SiGe.

The faceplate 1012 and the mirror 1004 also include a structural layer of SiGe layer 1030 deposited at a temperature of less than about 500 C, to enable the 2D modulators 1000 to be fabricated over the substrate 1016 following fabrication of the driver 1020 without restricting layout of the driver or deleteriously impacting functioning of CMOS transistors and devices of the driver.

FIGS. 11A and 11B illustrate a DPM^{TM} type 2D modulator 1100 formed using low temperature MEMS technology and including a single light reflective surface on a mirror extending over substantially the entire modulator. It is noted that such a 2D modulator does not require a second light reflective surface. Instead each light reflective surface in each 2D modulator is moved or displaced in relation to the light reflective surface of an adjoining 2D modulator to modulate the amplitude, phase or both of light incident on a multi-pixel array of a monolithic MEMS-based SLM.

FIG. 11A illustrates a schematic block diagram of a sectional side view of the 2D modulator 1100 in a quiescent or un-driven state. Referring to FIG. 11A, the 2D modulator 1100 includes an actuator layer 1102 suspended over a surface on a substrate 1104 by posts 1106 at corners of the 2D modulator. As with the embodiment shown in FIGS. 10A and 10B, the actuator layer 1102 includes an electrostatically deflectable central plate (CP 1102a) and a number of flexures 1102b through which the CP is flexibly or movably coupled to the posts 1106. A light reflective surface 1108 on a layer of reflective material 1109 is formed or deposited on a mirror 1110 supported above and separated from the CP 1102a by a central post 1112.

As in the embodiment described above, the actuator layer 1102 includes a taut structural layer of tensile, amorphous SiGe (SiGe layer 1114), which also functions as an actuator layer electrode.

The 2D modulator 1100 further includes a driver 1116 integrally formed in or on the substrate 1104 underlying at least some of the 2D modulators 1100, the driver operable to generate a voltage between a common electrode 1118 and the SiGe layer 1114 in the actuator layer 1102 to cause displacement of the CP 1102a. The SiGe layer 1114 is electrically coupled to one of a number drive channels in the driver 1116 through a conductor 1120 extending through one or more of the posts 1106, and to the common electrode 1118 through one or more vias 1122 and metal layers (not shown in these figures). Generally, multiple individual 2D modulators 1100 are grouped or ganged together under control of a single drive channel to function as a single pixel in a multi-pixel, linear array of a monolithic MEMS-based SLM.

FIG. 11B is detailed view of a portion of the actuator layer 1102, and the mirror 1110 of the 2D modulator 1100 shown in FIGS. 11B and 11C. Referring to FIG. 11C as in the embodiments described above, the SiGe layer 1114 can be deposited using CVD or PECVD, deposited at a low temperature of less than about 500 C. More preferably, the SiGe layer 1114 is implanted and annealed under conditions described above to yield a taut structural layer of tensile, amorphous SiGe layer 1114.

The mirror 1110 also includes a structural layer of SiGe layer 1126, deposited at a temperature of less than about 500 C, to enable the 2D modulators 1100 to be fabricated over the substrate 1104 following fabrication of the driver 1116 without restricting layout of the driver or deleteriously impacting functioning CMOS transistors and devices of the driver.

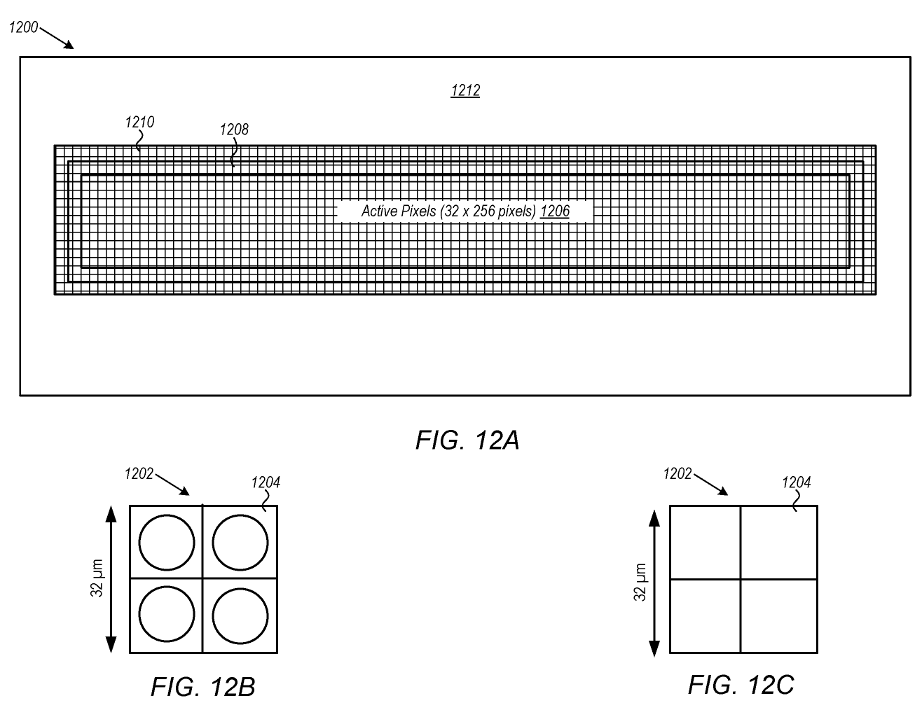

An exemplary embodiment of an array for a monolithic MEMS-based SLM including a multi-pixel, array 1200 of dense-packed, MEM-based 2D modulators will now be described with reference to the diagrams of FIGS. 12A to 12C. FIG. 12A is a planar top view a multi-pixel, array 1200 of dense-packed, MEMS-based 2D modulators. FIG. 12B illustrates a single pixel 1202 including a 2x2 arrangement of PLV^{TM} type 2D modulators 1204, and FIG. 12C illustrates a pixel 1202 including a 2x2 arrangement of DPM^{TM} type 2D modulators 1204. In the 2x2 arrangement shown, the fill-factor for the PLV^{TM} and DPM^{TM} are 92% and 94% respectively.

Referring to FIG. 12A, the array 1200 generally includes a central portion or sub-array of active pixels 1206, surrounded by a ring or border of dummy pixels 1208, which can be programmed for an arbitrary, static deflection by applying a constant DC voltage. The dummy pixels 1208 can be used to control light intensity at the perimeter of the illuminated active pixel 1206 (for example, to hold this border of dummy pixels dark). Immediately outside the border of dummy pixels is another ring or border of static pixels 1210, including flexure or actuator layers anchored to the substrate over which the array 1200 is formed, and which do not move. Outside the ring of static pixels 1210, there is light scattering border region 1212 to minimize reflections from this area. In the embodiment shown, the central portion of active pixels 1206 includes 8192 pixels arranged in a rectangular sub-array of 32 x 256 individual pixels, surrounded by a 3-pixel ring or border of dummy pixels 1208, surrounded by a 3-pixel ring or border of static pixels 1210.

Although not shown in these figures it will be understood that as shown and described above with respect to FIGS. 6 and 7, the monolithic MEMS-based SLM can further include a multi-channel, CMOS pixel driver operable to drive the active pixels 1206, and formed in or on a common or shared substrate at least partially underlying the array 1200.

In one embodiment, particularly useful for applications including marking, lithography, biomedical imaging and fluorescence microscopy the SLM is designed to modulate incident light at a wavelength (λ) of about 405 nanometers (nm). At this wavelength, the required stroke for the PLV^{TM} and DPM^{TM} are λ/4 (~100 nm) and λ/2 (~200 nm) respectively. Thus, an important objective of the design of the array 1200 of MEMS-based 2D modulators is to ensure these strokes could be achieved within a voltage range of the CMOS pixel driver.

The voltage response of both PLV^{TM} and DPM^{TM} type 2D modulators, is a function of pixel size, a geometry of the flexure or actuator layer of the 2D modulator 1204, an intrinsic stress of the actuator layer of the 2D modulators, and an air-gap separating the actuator layer from the surface of the substrate – determined by a thickness of a sacrificial layer (SAC thickness) over which the actuator layer was formed. Most of these variables are externally constrained. For example, pixel size (shown in FIGS. 12A and 12B as 32x32 µm) is selected or determined primarily by physical and electrical characteristics or parameters of the CMOS pixel driver, described in greater detail below. The SAC thickness is dictated by the required stroke, which in turn is dictated by the wavelength light to be modulated. Thus, only the geometry of the actuator layer is a free variable. Although the pixel 1202 could have been designed to include a single 32 µm 2D modulator 1204 , electrostatic modeling indicates that a 32 µm pixel including a 2x2 arrangement of 16 µm 2D modulators is within the operating range of the CMOS pixel driver and has several advantages over a single, larger 2D modulator 1204 including: (a) better planarity control, (b) improved image resolution for PLV^{TM} type 2D modulators, and (c) higher switching speeds and resonant frequency for both PLV^{TM} and DPM^{TM} type 2D modulators.

To design a SLM including an array of MEMS-based 2D modulators and a pixel driver with linearized phase response, the 2D modulator is modeled using a combination of a ‘capacitor-on-a spring’, and finite-element-analysis (FEA) of the electrostatically deflectable flexure or actuator layer of the 2D modulator.

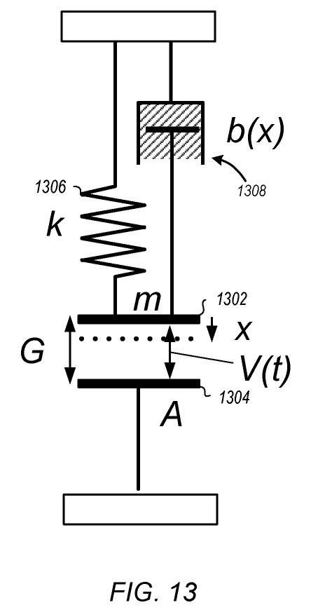

FIG. 13 is a schematic diagram modeling a 2D modulator as a capacitor-on-a-spring. Referring to FIG. 13, a voltage potential V(t) applied between an actuator electrode in an actuator layer 1302 of the 2D modulator and a lower or substrate electrode 1304 creates an electrostatic Coulomb attraction that deflects an actuator layer a distance x towards the substrate electrode. The electrostatic force is balanced by an elastic restoring force (represented by a spring 1306 in FIG. 13). The elastic restoring force, which is due to the taut silicon-nitride or silicon-germanium layer allows the 2D modulator to revert back to a neutral state or position once the electrostatic force is removed. In addition there is a damping force (represented by a damper 1308 in FIG. 13), arising from squeeze-film damping which slows or damps movement of the actuator layer 1302 by the Coulomb force and the elastic restoring force.

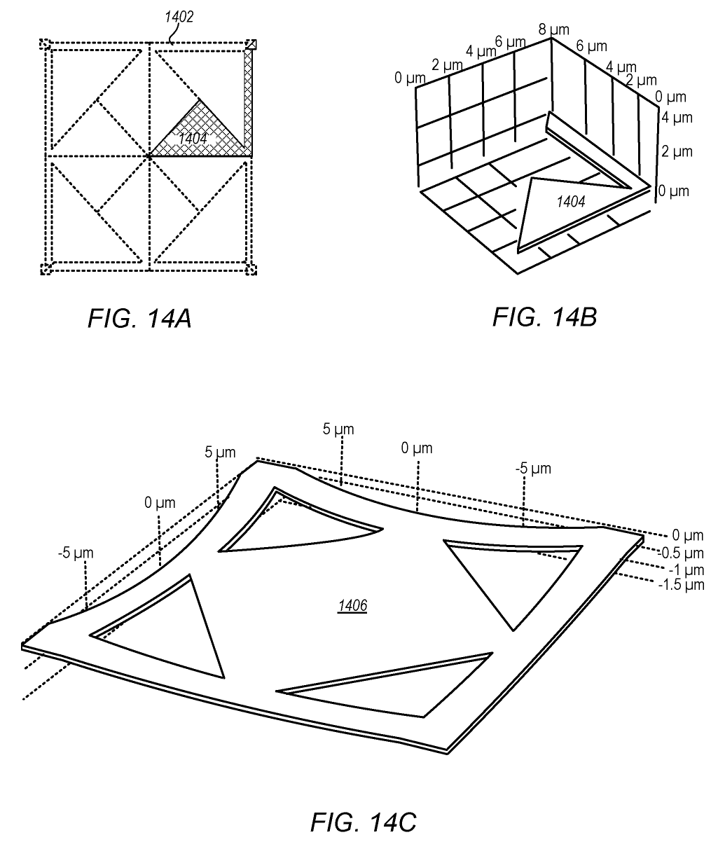

FIGS. 14A to 14C illustrate a multi-physics finite-element-analysis (FEA) of a flexure or actuator layer 1402 of a 2D modulator to derive non-linear drive voltages to operate the 2D modulator in linearly. Referring to FIG. 14A the analysis begins with defining a minimum MEMS geometry 1404 of the flexure or actuator layer 1402. Generally, minimum MEMS geometry 1404 includes a portion of the flexure or actuator layer 1402 that can be mirrored or folded along one or more axis of the actuator layer to form the geometry of substantially the entire actuator layer.

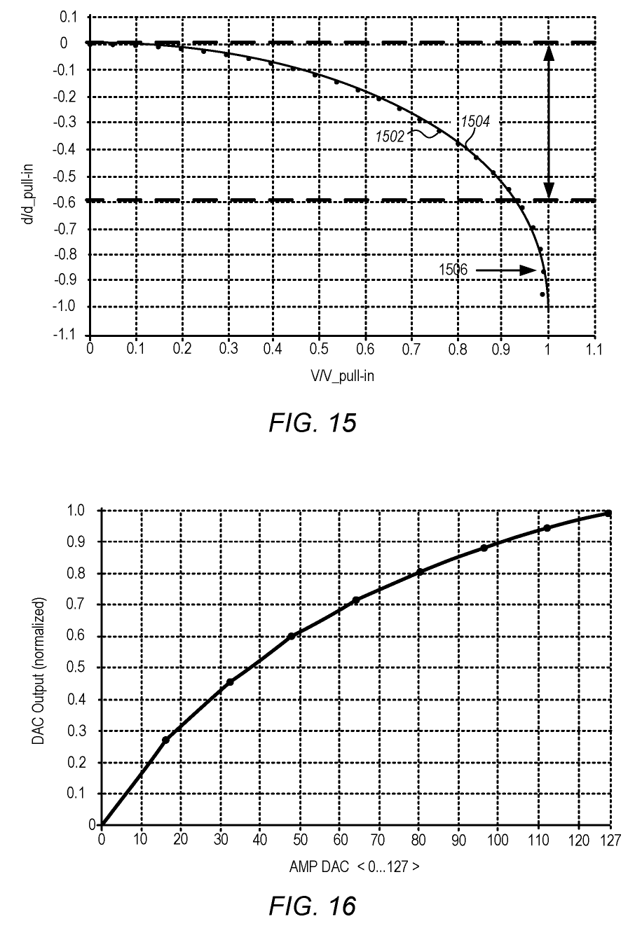

Next, electrical, mechanical and symmetry boundary conditions are selected applied at the boundaries of the minimum MEMS geometry 1404, as shown in FIG. 14B. finally, an equilibrium geometry for an actuated structure shape 1406 as shown in FIG. 14C is solved for using multi-physics FEA. By repeating this FEA for a range of applied voltages and tracing the trajectory of a center point of the actuator layer 1402, a deflection or displacement versus voltage (d-V) curve, shown in FIG. 15, for the 2D modulator is generated.

FIG. 15 is a plot of data points 1502 representing the d-V curve for a 2D modulator driven using drive voltages derived from the FEA of FIGS. 14A to 14C. Superimposed on these data points 1502 is a plot 1504 calculated from a capacitor-on-a-spring model of an actuator layer of a 2D modulator. Both the data points 1502 and the plot 1504 show a pull-in 1506 or snap-down singularity at the right-most point. By pull-in or snap-down it is meant a potentially destructive phenomenon in which the actuator layer of a 2D modulator driven by an actuator electrode snaps into contact with a surface or the substrate or substrate electrode and sticks there even when an electrostatic force is removed. To prevent damage to the 2D modulator or deflection the actuator layer of a 2D modulator is limited to less than about 60% of this pull-in deflection by limiting a drive voltage to less than about 92% of a pull-in voltage.

It is noted that near the origin or left side of FIG. 15 the plot 1504 shows large changes in voltages are needed to achieve even small deflections of the actuator layer of the 2D modulator. That is the plot 1504 has nearly a zero slope. Conversely, near pull-in 1506 or side of FIG. 15, the slope approaches infinity. It will be understood that these extremes make design of the pixel driver cumbersome and resolution the SLM in operation problematic.

To avoid the above issues, deflection increments from the d-V plot of FIG. 15 were interpolated, and the corresponding linear voltages extracted, as shown in FIG. 16. These linear voltages were then incorporated in a design of a pixel driver including a non-linear multi-bit digital-to-analog converter (DAC) to create a phase-linear pixel driver with linearized phase response. FIG. 16 is a deflection or displacement versus DAC output curve for a 2D modulator driven using linear voltages derived from the FEA of FIGS. 13A to 13C, and illustrating substantially linear deflection increments.

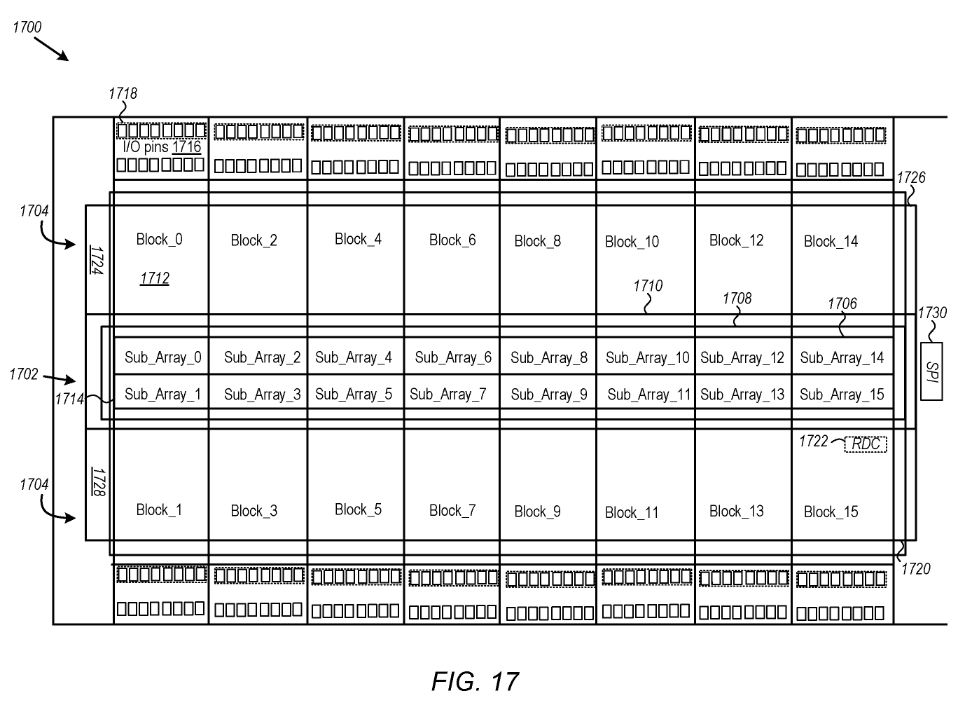

FIG. 17 is a schematic block diagram of a monolithic SLM 1700 including an array 1702 having integrally fabricated on a single, shared or common substrate with a pixel driver 1704 having linearized phase response adjacent to and at least partially underlying the array.

As described above with reference to FIGS. 12A to 12C, the array 1702 generally includes a central array or portion 1706 or active pixels, surrounded by a border of dummy pixels 1708, and static pixels 1710. Optionally or preferably, the SLM 1700 may further include a light scattering border region (not shown in this figure) surrounding the array 1702 and overlying the pixel driver 1704 to minimize reflections from this area.

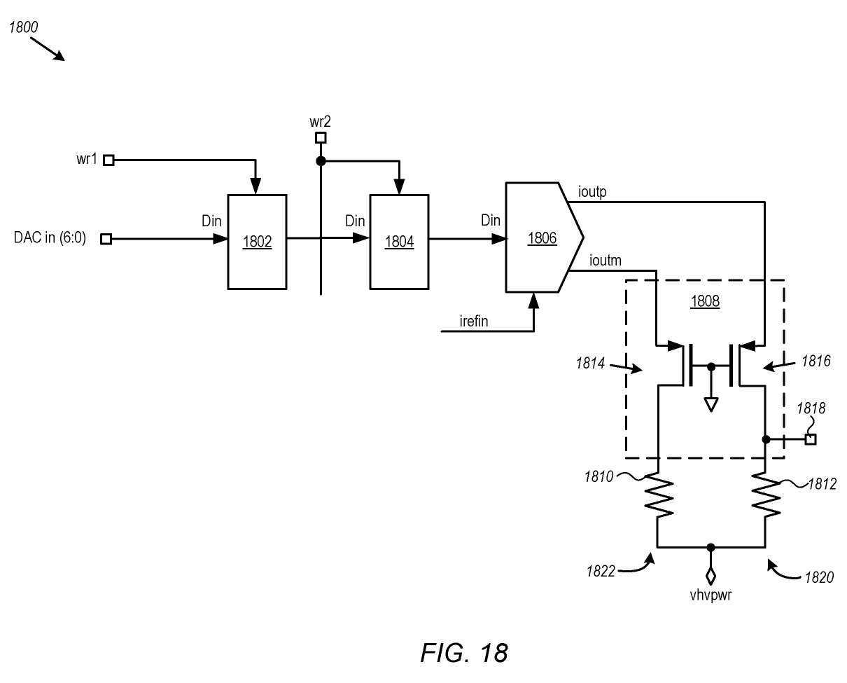

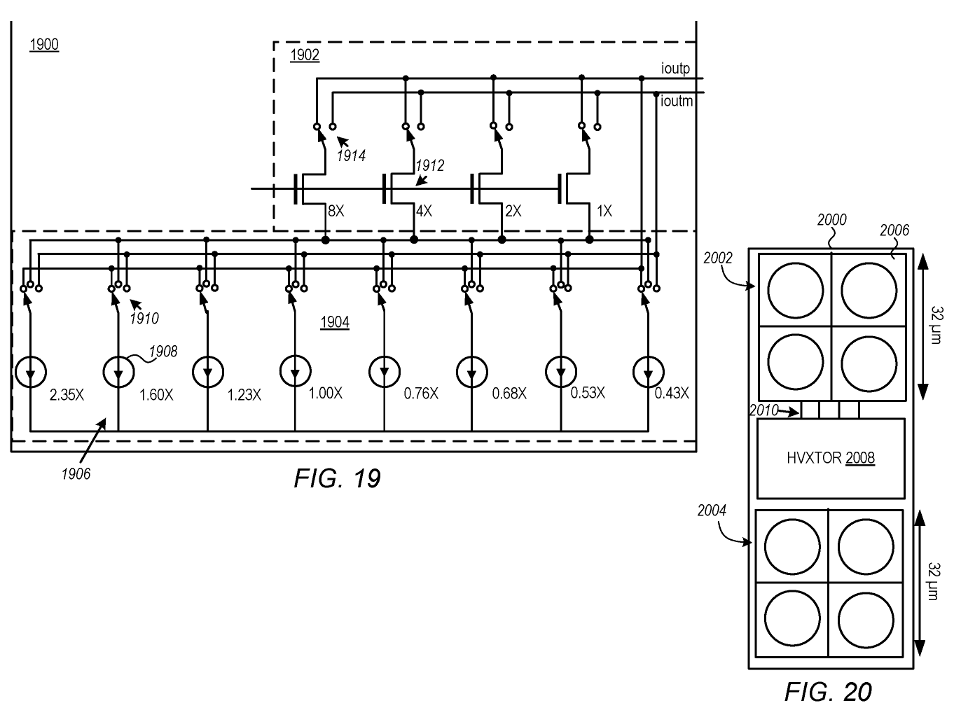

Briefly, the pixel driver 1704 architecture is highly modular and block-based including a modular tiling of a number of identical multi-channel blocks 1712 fabricated using a standard CMOS techniques. In one exemplary embodiment, the pixel driver 1704 is fabricated on a two hundred (200) by one hundred (100) millimeter (mm) die or chip using a 180 nm CMOS process, with seven (7) metal flows or layers, and with complementary 1.8V low-voltage transistors, formed in isolated N and P wells. Additionally, as explained in detail below with reference to FIG. 18, and FIG. 19, each channel in the multi-channel blocks 1712 further includes a number of high-voltage Laterally Diffused Metal Oxide Semiconductor (LDMOS) transistors and several, large, high resistivity poly-silicon resistors.

In the embodiment shown in FIG. 17, the pixel driver 1704 is composed of sixteen (16) identical multi-channel blocks 1712, each supporting a sixteen by thirty-two (16x32) pixel sub-array 1714 of five hundred and twelve (512) pixels. Each 512-channel block 1712 is a stand-alone circuit with sixteen (16) dedicated input and (I/O) pins 1716 including analog and digital voltage supply and ground pins, and a high-speed data interface (HSDI 1718) for loading multi-bit image data. The HSDI 1718 can include six or more Low-Voltage Differential Signaling (LVDS) pairs to transmit data. LVDS pairs carry a complementary signal, which helps to reduce electromagnetic interference and allows for high-speed data transmission with low power consumption. In one exemplary embodiment, the HSDI 1718 has four (4) LVDS pairs forming a 4-bit data bus, one (1) LVDS pair for a data clock, one (1) LVDS pair for a data strobe.

Additionally, the pixel driver 1704 can further include a number of peripheral circuits for configuring, controlling and testing the SLM 1700. These peripheral circuits can include: (a) biasing or individual pixel gain trim circuits 1720 for ‘pre-equalizing’ pixel driver outputs to eliminate electrical variation; (b) redundant drive channels 1722, allowing replacement of two defective channels in each multi-channel block 1712; (c) a data check function 1724 for monitoring data errors at the data interface; (d) dummy drivers 1726 to program the border of dummy pixels 1708; and (e) a programmable test bus 1728 for testing driver outputs and other analog signals at wafer- or module-level. All of these features are controlled by a global serial peripheral interface (SPI 1730) which allows writing and reading from digital control registers (not shown) either in the SLM 1700 or in a by a controller, such as a field-programmable gate-array (FPGA) in a system (not shown) in which the SLM is included. In use, communication through the SPI is handled by serial commands interpreted by firmware operating at the module level.

User imaging data is delivered to the SLM 1700 after being properly divided and sequenced for each multi-channel blocks 1712 by the controller or FPGA in the system in which the SLM is included. At the block level, loading of imaging data is initiated with receipt of a data strobe, whereupon five hundred and twelve (512) 7-bit digital amplitude words are sequentially latched in each multi-channel blocks 1712 in dual-data-rate (DDR) on the rising and falling edge of the data clock. With data clock running at 136 MHz, all channels are updated within a 250 kHz or four (4) µs frame period, and the total data throughput for the SLM 1700 of about fourteen point three (14.3) gigabits per second (Gbps).

FIG. 18 is a schematic block diagram of a single drive channel 1800 in a pixel driver, such as in the multi-channel block 1712 of the pixel driver of 1704 of FIG. 17, configured or operable to generate a linearized phase response. Referring to FIG. 18, each drive channel 1800 includes two cascaded registers 1802, 1804, which function as latches to latch amplitude data as it arrives in from the data interface, a non-linear, a multibit digital-to-analog converter (DAC 1806) The DAC 1806 is a differential, current mode DAC, generating complementary output currents ioutp, ioutm, and is operable to provide a constant power consumption independent of image data, while minimizing hysteresis and crosstalk between adjacent drive channels. The full-scale DAC 1806 output range is programmable from 5 to 50V by means of an adjustable reference gain (irefin).

The DAC output currents (ioutp, ioutm) flow through a two-stage cascode amplifier or cascode 1808 and a pair of high-value, poly-silicon load resistors 1810, 1812, coupled in parallel between the cascode and a high voltage power supply (HVPS). The cascode 1808 includes a common source stage feeding a common gate stage when using high, voltage metal-oxide-silicon (HV MOS) transistors 1814, 1816. Generally, the HV MOS transistors can be either p-channel or n-channel devices. However, as PMOS transistors are generally physically smaller than NMOS, preferably the transistors 1814, 1816, are HV PMOS devices to reduce a footprint or size of the pixel driver.

In the embodiment shown, each HV PMOS transistor 1814, 1816 has a source terminal coupled to one of the complementary output currents ioutp, ioutm, of the DAC 1806 and a drain terminal coupled through one of the pair of poly-silicon load resistors 1810, 1812, to the HVPS. A drive voltage to drive one or more 2D modulators in one or more pixels in an array is coupled from an output node 1818 between the drain of one of the HV PMOS transistors 1816 and one of the pair of poly-silicon load resistors 1810, 1812 forming an output cascode arm 1820. The drain of the remaining HV PMOS transistor 1814 and the other poly-silicon load resistor 1810 form an unused, or dump cascode arm 1822 of the cascode amplifier. In some embodiments, the unused or dump cascode arms from two adjacent drive channels 1800 are combined to share a single, HV PMOS transistor 1814, reducing the number of required HV PMOS transistors for each drive channel from four to three, thereby further reducing the footprint of the pixel driver.

It will be understood that the architecture of the drive channel 1800 allows for an accurate current-to-voltage conversion without using an active amplifier. The full-scale DAC output range is programmable from 5 to 50V by means of an adjustable reference gain (irefin). A further advantage of this drive channel design is its minimal use of analog circuitry, especially high-voltage devices. Analog circuitry used limited to the low-voltage DAC and the high-voltage cascode and load resistors, reducing power consumption and improving pixel-to-pixel uniformity.

An embodiment of a non-linear, current mode DAC 1900 suitable for use in the pixel driver 1704 of FIG. 17 and drive channel 1800 of FIG. 18 will now be described with reference to FIG. 19.

An embodiment of a non-linear, current mode DAC 1900 suitable for use in the pixel driver 1704 of FIG. 17 and drive channel 1800 of FIG. 18 will now be described with reference to FIG. 19. Generally, the DAC 1900 has a dual-stage architecture, and includes an unequally weighted primary or thermometer code DAC 1902 combined with a weighted binary code interpolator 1904. In the embodiment shown in FIG. 19 the thermometer code DAC 1902 is an unequally weighted 3-bit (8-segment) thermometer code DAC, in which each segment 1906 is coupled in parallel and includes a weighted current source 1908 and a switch 1910 controlled by decoding logic (not shown) in the DAC in response to a thermometer code, generated by the 3 most significant bits (MSBs) of the multi-bit imaging data or amplitude word received from the latches or registers 1802, 1804, shown in FIG. 18. The binary code interpolator 1904 is a 4-bit (16-segment) weighted binary code interpolator including four (4) transistors 1912 coupled in parallel and through switches 1914 to the DAC 1900 outputs ioutp, ioutm. The 4-bit weighted binary code interpolator 1904 can be driven directly by the 4 least significant bits (LSBs) of the multi-bit imaging data or amplitude word. The implementation of a 7-bit current mode DAC 1900 shown FIG. 19 was used to achieve the non-linear 7-bit output shown in FIG. 16, and this design ensures monotonicity and minimizes differential non-linearities in DAC output.

A primary challenge in designing a monolithic SLM including an optical array of pixels including MEMS-based 2D modulators integrally fabricated on a shared or common substrate with a pixel driver adjacent to and at least partially underlying the array is fitting drive channels and circuits into the footprint of the array. FIG. 20 is a schematic block diagram of a dual-pixel layout of a portion of monolithic SLM 2000 including two pixels 2002, 2004, each including one or more 2D modulators 2006 driven by one or more drive channels, and further including HV PMOS transistors and poly-silicon load resistors fabricated using CMOS technology in a high voltage transistor (HVXTORS) region 2008 between the two pixels 2002, 2004. The HV PMOS transistors and poly-silicon load resistors are large features and need to be located as close to the 2D modulators as possible in order to minimize wiring capacitance. This is not true for the DACs however, which can be placed outside of or adjacent to the optical array with multiple DAC current lines 2010 running in parallel down each column of the array.

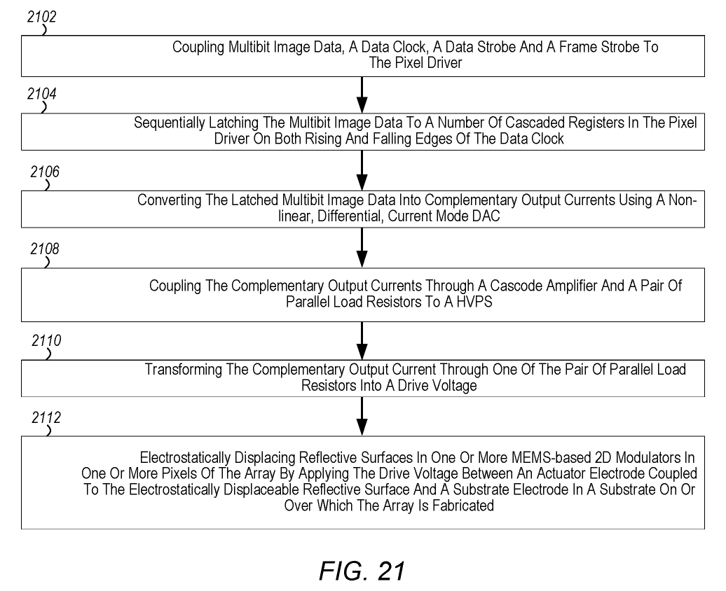

A method for operating a MEMS-based SLM including an array of pixels with 2D modulators and a pixel driver with linearized phase response will now be described with reference to the flowchart of FIG. 21. Referring to FIG. 21, the method begins with coupling multibit image data, a data clock, a data strobe and a frame strobe from a controller in a system in which the SLM is incorporated to the pixel driver (step 2102).

Next, on receipt of the data strobe, the multibit image data is sequentially latched to a number of cascaded registers in the pixel driver (step 2104). Preferably, loading the image data is initiated with receipt of the data strobe, whereupon a single frame consisting of, for example, five hundred and twelve (512), 7-bit digital amplitude words are sequentially latched in dual-data-rate (DDR) on both rising and falling edge of the data clock. For a system having a data clock running at one hundred and thirty-six (136) megahertz (MHz), all drive channels are updated within a two hundred and fifty (250) kilohertz kHz or four (4) µs frame period. Thus, as noted above for a monolithic MEMS-based SLM driven by an integrally formed, non-linear CMOS pixel driver has a data throughput of about fourteen point three (14.3) gigabits per second (Gbps).

The latched multibit image data is converted into complementary output currents (ioutp, ioutm), using a non-linear, differential, current mode DAC), as shown in FIG. 18 (step 2106). Generally, as shown in FIGS. 19, the DAC is an unequally weighted thermometer code DAC driven by the most significant bits (MSBs) of the multibit image data, and a weighted binary code interpolator driven by least significant bits (LSBs) of the multibit image data, and converting the latched multibit image data into complementary output currents includes converting the MSBs of the multibit image data into a first, weighted current, and combining the weighted current with a second current from the binary code interpolator to preserve monotonic operation of the pixel driver

The complementary output currents are coupled through a cascode amplifier and a pair of parallel load resistors to a HVPS, as shown in FIG. 18 (step 2108).

Next, the complementary output current through one of the pair of parallel load resistors is transformed into a drive voltage (step 2110), and the reflective surfaces in one or more of the 2D modulators electrostatically displaced by applying the drive voltage between an actuator electrode coupled to the reflective surface and a substrate electrode in a substrate on or over which the array of the SLM is fabricated (step 2112). As noted above the pixel driver is configured or operable to provide a linearized phase response in which the electrostatically displaceable reflective surfaces are displaced by a uniform, linearly increasing amount or quantum up to a maximum displacement through which the actuator layer can be displaced without resulting in snap-down by application of non-linearly increasing drive voltages between the actuator electrode and the substrate electrode.

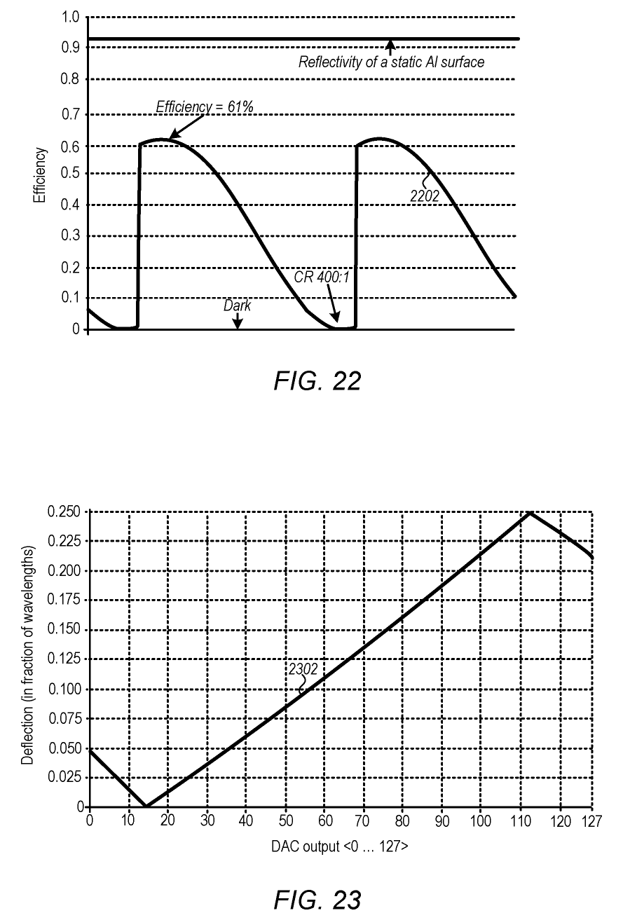

FIG. 22 is a curve illustrating the spectral efficiency of a monolithic, amplitude modulating SLM including an array of PLV^{TM} type 2D modulators driven between a fully dark state and a light state, by an integrally formed non-linear, CMOS pixel driver with a linearized phase response, as compared to the a light or fully reflecting state achieved by a static, planar aluminum (AI) reflector. Referring to FIG. 22, optical characterization of the SLM was performed using continuous-wave laser with a 405 nm wavelength as an incident light with a fifteen degree (15°) angle of incidence, a 100 µm spot (full-width 1/e²) and a 100 milliwatt (mW) beam power. FIG. 22 shows a zero-order (specular) intensity-voltage curve 2202 as the amplitude DAC is ramping from zero 0-127. The measured efficiency of the SLM, about 61%, is lower than a maximum theoretical efficiency of about 87%, but higher than expected from a linear 7-bit driver. It is also noted that the measured zero-order contrast ratio is greater than about 400:1, further highlighting advantages of the non-linear driver design, in which voltage resolution increases concurrently with applied voltage.

FIG. 23 is a plot of deflection of the reflective surfaces of an amplitude modulating SLM driven by a non-linear pixel driver versus the DAC output (deflection-vs-DAC), extracted from the intensity-vs-DAC plots. The linear slope of the plot, represented by line 2302, indicates that the phase-linear driver is working, and providing the desired uniform displacement resolution across a stroke of the actuator layer of the 2D modulator.

Thus, embodiments of a monolithic SLM including a multi-pixel, linear array of dense-packed, MEMS-based 2D modulators, and an integrally fabricated CMOS pixel driver with a phase-linear response have been described. The SLM has been described with the aid of and reference to functional and schematic block diagrams illustrating implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be understood that the Detailed Description section, and not the Summary and Abstract sections, is intended to be used to interpret the claims. The Summary and Abstract sections can set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

1. A spatial light modulator (SLM) comprising:
an array of pixels arranged over a surface of a substrate, each pixel including at least one microelectromechanical system (MEMS)-based, two-dimensional (2D) modulator, wherein each 2D modulator includes an electrostatically displaceable reflective surface to modulate light incident thereon; and
a pixel driver with linearized phase response, the pixel driver including multiple channels, each channel operable to electrostatically displace the reflective surfaces of 2D modulators in one or more pixels by a uniform, linearly increasing quantum up to a predetermined maximum displacement in response to non-linearly increasing electrostatic drive voltages between an actuator electrode coupled to the electrostatically displaceable reflective surface and a substrate electrode in the substrate.

2. The SLM of claim 1 wherein the pixel driver comprises a modular architecture including a plurality of blocks, each block having a number of input and output (I/O) pins to receive analog and digital supply voltages and grounds, a data interface including a plurality of (LVDS) pairs for receiving a multibit image data, a data clock and a data strobe, and wherein each block is operable to drive a number of channels in a sub-array in the array of pixels.

3. The SLM of claim 2 wherein each of the plurality of blocks comprise a number of cascaded registers operable to receive the multibit image data, a non-linear digital-to-analog-converter (DAC) coupled to the number of cascaded registers, a cascode amplifier coupled to the DAC, and a pair of load resistors coupled in parallel between the cascode amplifier and a high voltage power supply (HVPS).

4. The SLM of claim 3 wherein the DAC is a differential, current mode DAC, generating complementary output currents operable to provide a constant power consumption independent of image data, and minimize hysteresis and crosstalk between adjacent channels.

5. The SLM of claim 4 wherein the cascode amplifier comprises a pair of p-channel metal–oxide–semiconductor (HV PMOS) transistors with common gate terminals, each HV PMOS transistor having a source terminal coupled to one of the complementary output currents of the DAC and a drain terminal coupled through one of the pair of load resistors to the HVPS, and wherein a drive voltage to drive the number of channels in the sub-array is coupled from an output node between the drain of one of the HV PMOS transistors and one of the pair of load resistors forming an output cascode arm, the drain of the remaining HV PMOS transistor and the other load resistor forming an unused, dump cascode arm of the cascode amplifier.

6. The SLM of claim 5 wherein unused, dump cascode arms from two adjacent channels are combined to share a single HV PMOS transistor.

7. The SLM of claim 3 wherein the DAC is a thermometer code DAC comprising an unequally weighted 3-bit segment driven by three most significant bits (MSBs) of the multibit image data combined with a 4-bit segment weighted binary code interpolator driven by four least significant bits (LSBs) of the multibit image data to preserve monotonic operation of the pixel driver.

8. The SLM of claim 2 wherein each of the plurality of blocks comprise one or more of a number of gain trim circuits operable to pre-equalize outputs to each of the number of channels in the sub-array, a number of redundant channels to enable replacement of defective channels in each of the plurality of blocks, and a data check function operable to monitor data errors at the data interface.

9. The SLM of claim 2 wherein the pixel driver comprises a programmable test bus for testing outputs to each of the number of channels.

10. The SLM of claim 3 wherein the pixel driver is integrally formed in the substrate with the array of pixels, and wherein the registers, cascode amplifier and load resistors in each of the plurality of blocks are formed underlying the array of pixels.

11. The SLM of claim 1 wherein the array of pixels comprises a border of programmable dummy pixels surrounding an array of active pixels operable to control light intensity at a perimeter of the array of pixels.

12. The SLM of claim 11 wherein the array of pixels further comprises a border of static pixels surrounding the programmable dummy pixels, each of the static pixels including at least one 2D modulator, each 2D modulator including a static light reflective surface.

13. The SLM of claim 12 further comprising a light scattering region surrounding the array operable to minimize reflections from this area.

14. A microelectromechanical systems (MEMS) based spatial light modulator (SLM) for modulating light incident thereon, the SLM comprising:
a two-dimensional (2D) array of pixels arranged over a surface of a substrate, each pixel including at least one microelectromechanical system (MEMS) modulator, wherein each 2D modulator includes an electrostatically displaceable actuator layer suspended above an upper surface on the substrate, the actuator layer including an actuator electrode and comprising a layer of tensile, amorphous silicon-germanium (SiGe layer), and a mirror supported by and separated from the upper surface on the substrate by the actuator layer, the mirror including a light reflective surface facing away from the actuator layer; and
a pixel driver with linearized phase response, the pixel driver including multiple channels, each channel operable to electrostatically displace the reflective surfaces of one or more 2D modulators in one or more pixels by a uniform, linearly increasing quantum up to a predetermined maximum displacement through application of a non-linearly increasing electrostatic drive voltages between the actuator electrode and a substrate electrode in the substrate.

15. The SLM of claim 14 wherein the pixel driver comprises a modular architecture including a plurality of blocks, each block having a number of input and output (I/O) pins to receive analog and digital supply voltages and grounds, a data interface including a plurality of (LVDS) pairs for receiving multibit image data, a data clock and a data strobe, and wherein each block is operable to drive a number of channels in a sub-array in the array of pixels.

16. The SLM of claim 15 wherein each of the plurality of blocks comprise a number of cascaded registers operable to receive the multibit image data, a non-linear digital-to-analog-converter (DAC) coupled to the number of cascaded registers, a cascode amplifier coupled to the DAC, and a pair of load resistors coupled in parallel between the cascode amplifier and a high voltage power supply (HVPS).

17. The SLM of claim 16 wherein the DAC is a differential, current mode DAC, generating complementary output currents operable to provide a constant power consumption independent of image data, and minimize hysteresis and crosstalk between adjacent channels.

18. The SLM of claim 17 wherein the DAC is a thermometer code DAC comprising an unequally weighted 3-bit segment driven by three most significant bits (MSBs) of the multibit image data combined with a 4-bit segment weighted binary code interpolator driven by four least significant bits (LSBs) of the multibit image data to preserve monotonic operation of the pixel driver.

19. A method for operating a spatial light modulator (SLM) including an array of pixels and a pixel driver with linearized phase response, the method comprising:
coupling multibit image data, a data clock, and a data strobe to the pixel driver;
on receipt of the data strobe, sequentially latching the multibit image data to a number of cascaded registers in the pixel driver on both rising and falling edges of the data clock;
converting latched multibit image data into complementary output currents using a non-linear, differential, current mode digital-to-analog-converter (DAC);
coupling the complementary output currents through a cascode amplifier and a pair of parallel load resistors to a high voltage power supply (HVPS);
transforming the complementary output current through one of the pair of parallel load resistors into a drive voltage; and
electrostatically displacing reflective surfaces in one or more microelectromechanical system (MEMS)-based two-dimensional modulators in one or more pixels of the array by applying the drive voltage between an actuator electrode coupled to the electrostatically displaceable reflective surface and a substrate electrode in a substrate on or over which the array is fabricated,
wherein the electrostatically displaceable reflective surface is displaced by a uniform, linearly increasing quantum up to a maximum displacement through application of non-linearly increasing drive voltages between the actuator electrode and the substrate electrode.

20. The method of claim 19 wherein the DAC comprises an unequally weighted thermometer code DAC driven by a number of most significant bits (MSBs) of the multibit image data, and a weighted binary code interpolator driven by least significant bits (LSBs) of the multibit image data, and wherein converting latched multibit image data into complementary output currents comprises converting the number of MSBs of the multibit image data into a first, weighted current, and combining the weighted current with a second current from the binary code interpolator to preserve monotonic operation of the pixel driver.
